(19) United States
(12) Patent Application Publication
(10) Pub. No.: US 2013/0152869 A1
(43) Pub. Date: Jun. 20, 2013

(54) Animal Leash

(71) Applicant: Cameron Morton, Newtown (AU)

(72) Inventor: Cameron Morton, Newtown (AU)

(21) Appl. No.: 13/712,969

(22) Filed: Dec. 13, 2012

(30) Foreign Application Priority Data
Dec. 20, 2011 (AU) 2011905310

(51) Int. Cl. A01K 13/00; A01K 27/00

(52) U.S. Cl. CPC A01K 13/001; A01K 27/003
USPC 119/665; 119/795

(57) ABSTRACT

An animal leash apparatus comprising: an elongate hose portion having opposing ends; a hose nozzle at one end of the hose portion; a tap connector at the other end of the hose portion; and a clip at the same end of the hose portion as the tap connector, for enabling the animal leash to be coupled to an article worn by an animal.

### TECHNICAL FIELD

The present invention relates to animal leashes.

The invention has been developed primarily for the use as a dog leash, and will be described hereinafter with reference to this application. However, it will be appreciated that the invention is not restricted this particular field of use.

### BACKGROUND

Any discussion of the prior art throughout the specification should in no way be considered as an admission that such prior art is widely known or forms part of the common general knowledge in the field.

There are many animal leashes available for use while walking animals.

A problem with walking animals such as dogs outdoors in parks, ovals or beaches is that the animals often end up covered in mud, sand or dirt and need to be washed or rinsed off upon returning home. This is problematic because it typically requires the dog, say, to enter the home covered in dirt, or if rinsed in the garden before entering the home the dog can end up traipsing wet dirt around the home.

Often, the only available option is to find a tap or shower at the beach, oval or park to rinse off the animal outdoors before returning home. However, it is difficult to get animals to comply with a carer's efforts to wash them down under a tap or shower, and it is often difficult to manoeuvre the water flow to wash off all the dirt—particularly for long haired dogs whose hair traps a lot of the dirt.

There is a need for a way to wash off animals anywhere they are likely to get dirty (e.g. while at the park, oval or beach), which allows the flow of water to be suitable directed to remove dirt and which is sufficiently portable and convenient to carry with the dog at all times.

US 2001/0015179 discloses use of a length of elastic hose as the elastic, extendable outer band of a fixed diameter harness for guiding and retaining a toddler while learning to walk, or an animal such as a dog while walking. The harness allows the animal or child to be guided while walking, even without a lead. This is achieved through use of an elastic hose (outer band) of the harness, which sits on the outer surface of an inner band (fixed collar or harness) that encircles the neck and is inwardly directed. The hose (outer band) is held while the animal or child is walking. The hose (outer band) lengthens or extends counter to force applied while the animal or child walks, permitting the carer to retain and guide the animal using the extendable elastic band (hose) of the harness without needing to stoop or causing the collar to narrow in diameter and choke the animal or child. The extendable hose functions as an elastic band or flat elastic tube—the shape of which is comfortable to wear and does not form loops on which an animal could catch itself and cause injury.

U.S. Pat. No. 6,397,783 describes a restraint for animals—namely, a harness and leash that is made from a strap-like woven tubular fabric (hose). The tubular fabric reduces pressure around the edges of the strap for comfort. The tubular fabric also has padding inserted into it—to further improve comfort for the animal and person handling it. Thus the tubular fabric functions as housing for padding and is configured to provide comfort by distributing pressure away from the edges of the strap.

While each of US 2001/0015179 and U.S. Pat. No. 6,397,783 includes a hose-shaped component, these features are directed towards providing comfort (no harsh edges that cut into the animal when worn or into the hand of the carer holding the device). Neither of these devices uses a hose-shaped component to facilitate washing down of dirty animals, and indeed could not be converted to use for this purpose as:
a) the hose-shaped component of US 2001/0015179 is essentially an elastic band or tube coupled to a fixed-diameter component (harness). The elastic band or tube is threaded through a housing on the straps of the harness. The elastic band or tube extends through an opening in the housing. This allows the band or tube to extend or lengthen as the animal or child walks away (thus countering the increase in force as the child or animal moves away from the carer). This allows the carer to guide the wearer of the restraint without stooping or risking choking of the animal or child. The tube shape adds comfort;
b) the hose-shaped component of U.S. Pat. No. 6,397,783 distributes forces away from the edges of the strap-like component and also contains padding, both for the purpose of increasing comfort to the wearer and to the carer handing the restraint.

It would be an advantage to have a device that facilitates washing off animals anywhere they are likely to get dirty (e.g. while at a park, oval or beach), and which could also double as a leash, minimising what needs to be carried along for the walk.

### OBJECT OF THE INVENTION

It is an object of the present invention to overcome or ameliorate at least one of the disadvantages of the prior art, or to provide a useful alternative.

It is an object of the invention in its preferred form to provide a device that facilitates washing down of an animal in an outdoor recreational area and also functions as a leash, making it convenient to carry.

### SUMMARY OF THE INVENTION

According to an aspect of the invention there is provided an animal leash comprising:
a) an elongate hose portion having opposing ends;
b) a hose nozzle at one end of the hose portion;
c) a tap connector at the other end of the hose portion.

Preferably, the animal leash further includes a clip at the same end of the hose portion as the tap connection, for connecting the animal leash to one or more of:
i. an animal collar;
ii. an animal harness.

Preferably, the hose nozzle is reversibly house in a nozzle housing, which resides at one end of the hose portion.

Further preferably, the nozzle housing is moveable to allow the hose nozzle to be moved between an exposed state for use and a stowed state when not in use.

Further preferably again, the tap connector is reversibly housed in a connector housing, which resides at a far end of the hose portion. The connector housing is moveable to allow the tap connector to be moved between an exposed state for use and a stowed state when not in use.

Preferably also, the hose portion is a woven integral hose made of suitable textile and then coated or lined with a suitable mater. More preferably, the hose portion is a woven integral hose made of polyester or nylon filament. More preferably, the a woven integral hose is then coated or lined with elastomeric polyurethane.

According to another aspect of the invention there is provided an animal leash comprising:
a) an elongate hose portion having opposing ends;
b) a hose nozzle at one end of the hose portion;
c) a tap connector at the other end of the hose portion; and
d) a leash housing intermediate to the hose nozzle and the tap connector, wherein the leash housing includes:
   i. a retractor mechanism to enable the hose portion to move between a retracted state and an extended state;
   ii. a locking means to lock/brake and unlock retraction of the hose portion.

The leash housing further includes a connection means for connecting the hose portion to the hose nozzle.

Preferably, the hose nozzle is adjustable to allow adjustment of the flow of water.

Further preferably, the animal leash includes a clip at the same end of the hose portion as the tap connector, for connecting the animal leash to one or more of:
i. an animal collar;
ii. an animal harness.

The invention thus provides a device that facilitates washing down of an animal in an outdoor recreational area and also functions as a leash, making it convenient to carry.

For a better understanding of the invention and to show how it may be performed, a preferred embodiment will now be described, by way of non-limiting example only, with reference to the accompany drawings.

### BRIEF DESCRIPTION OF DRAWINGS

A preferred embodiment of the invention will now be described, by way of example only, with reference to the accompanying drawings in which:

FIG. 1 is a plan view of an animal leash according to an embodiment;

FIG. 2A shows the retractable animal leash in a retracted position, with the leash housing of the retracted leash shown in cross section so that the internal contents can be seen;

FIG. 2B shows the retractable leash in an extended position;

FIG. 3 is a side view of an alternative arrangement of the retractable animal leash of FIG. 2A and FIG. 2B;

FIG. 4 is the embodiment of FIG. 1 coiled for storage;

FIG. 5A is a close up of the hose nozzle housing of the embodiment of FIG. 1, showing the hose nozzle in the stowed state, in the nozzle housing;

FIG. 5B is a close up of the hose nozzle housing of the embodiment of FIG. 1, showing the nozzle housing moved so that the hose nozzle is in an exposed state, ready for use;

FIG. 6A is a plan view of embodiment of FIG. 1 showing the tap connector in the stowed state, in the connector housing;

FIG. 6B is a plan view of the same embodiment as in FIG. 6A, showing the connector housing moved so that the tap connector is in an exposed state, ready for use—i.e. available for connection to a tap;

FIG. 6C is a perspective view of the tap connector of FIG. 6B, showing the inside of the tap connector.

### DETAILED DESCRIPTION

The invention provides a device that facilitates washing down of an animal in an outdoor recreational area and also functions as a leash, making it convenient to carry.

Specific embodiment are described below by way of example only.

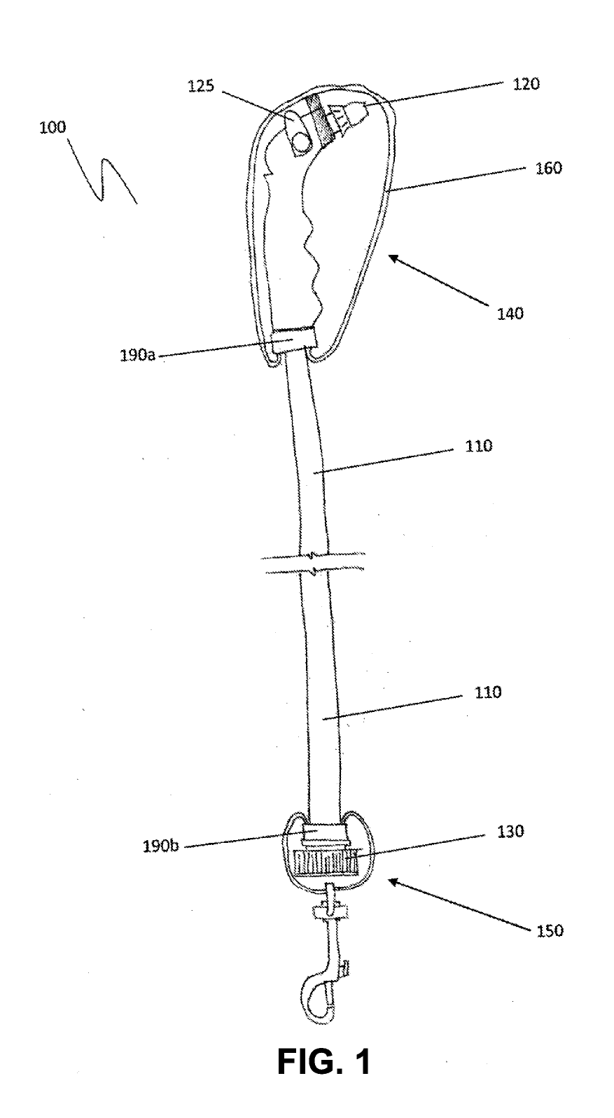

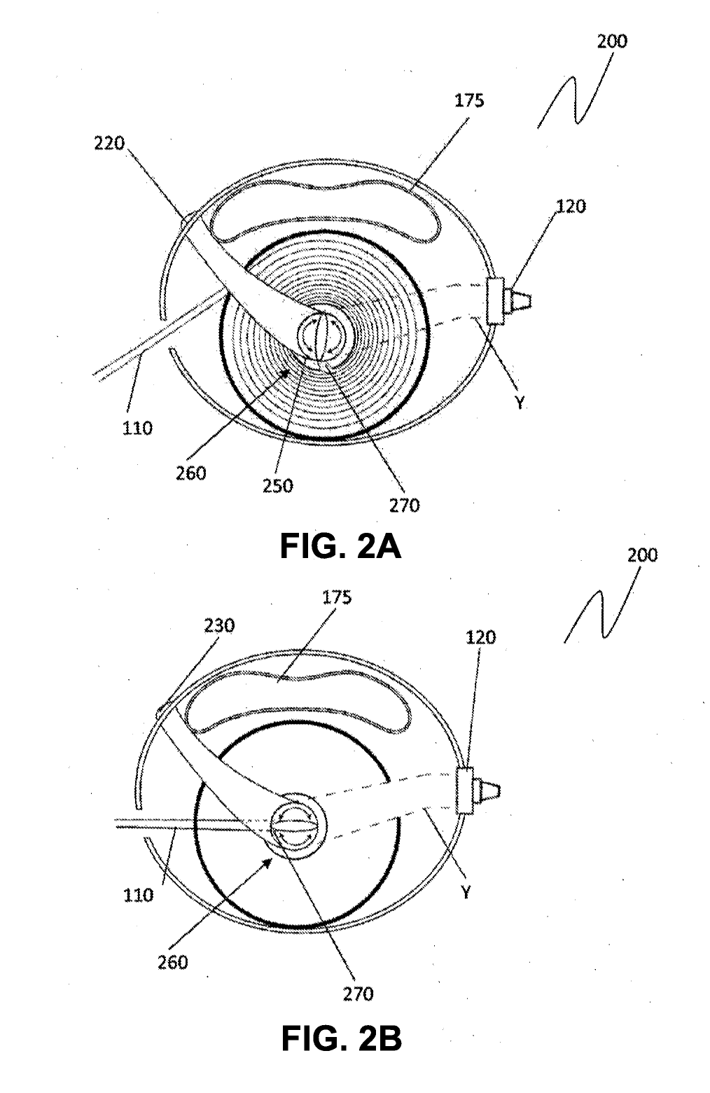

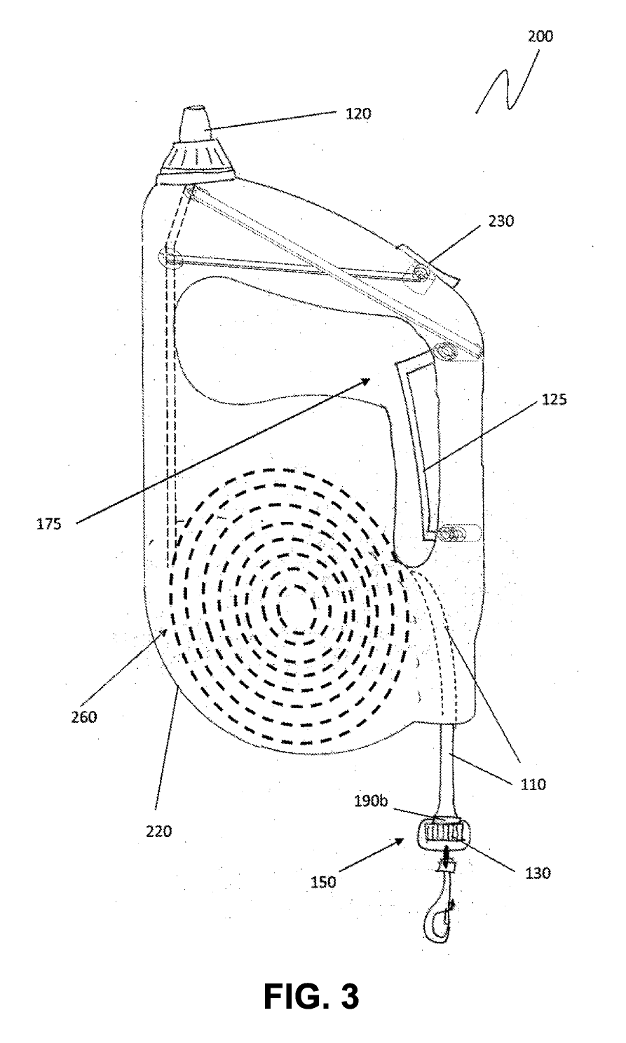

The animal leash (e.g. item 100 in FIG. 1, item 200 in FIG. 2A, FIG. 2B and FIG. 3) includes an elongate hose portion 110 having opposing ends that is also suitable for use as an animal leash. The hose portion 110 is a woven integral hose made of any suitable textile, such as polyester or nylon filament coated or lined with a suitable material to allow carriage of water, e.g. elastomeric polyurethane, but it is not limited to this sort of material. An example is a small diameter fire hose—the diameter is important for the animal's comfort when wearing the hose portion 110 as an animal leash, and for portability and comfort of the person caring for or handling the animal (or a larger diameter hose requires larger, heavier fittings, thereby limiting portability).

It will be appreciated that FIG. 2A and FIG. 2B disclose two side views of an animal leash according to an alternative embodiment than illustrated in FIG. 1—a retractable embodiment.

The material of the hose portion no makes it lightweight and flexible for comfort and portability, yet able to withstand internal water pressure. When not being used to direct a flow of water, the hose portion no assumes a substantially flat configuration so that the animal leash appears similar in form to a nylon webbing animal leash. This makes the animal leash 100, 200 comfortable to wear, for the animal, and to handle, for the carer.

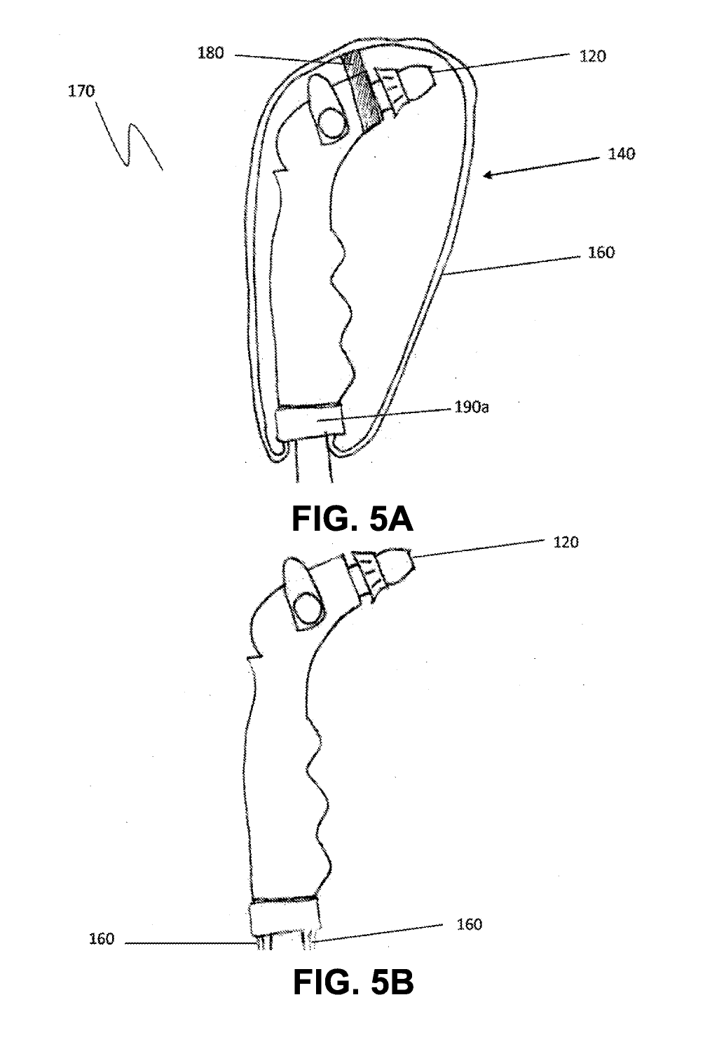

The hose portion no forms a substantially flat tube of woven textile (except when filled with water), extending between:
a) a hose nozzle (item 120 in FIG. 1 and FIG. 2A) at one end; and
b) a tap connector 130 at the other end—see FIG. 5A and FIG. 5B.

Referring to the embodiment 100 in FIG. 1, each of the hose nozzle 120 and tap connector 130 is reversibly housed at its respective ends within moveable housing (140, 150). Moving the housing enable each of the hose nozzle 120 and tap connector 130 to be moved between:
a) an “exposed” state, ready for use to wash down an animal; and
b) a “stowed” state, to store the hose nozzle 120 or tap connector 130 out of the way while walking an animal or when the leash is not in use.

In an embodiment, the nozzle housing 140 is a length of nylon webbing, neoprene, elastic tubing or other suitable material attached at its far ends to the hose portion, to form a loop 160 as shown in FIG. 1. A close up of the nozzle housing 140 in FIG. 1 is also shown in FIG. 5A. In its stowed state, the hose nozzle 120 sits within the loop 160, the loop 160 and the hose nozzle 120 together forming a handle portion 170 for the animal leash 100. The nozzle housing 140 also includes a securing means 180 to retain the hose nozzle 120 in a position in the handle portion 170.

It will be appreciated that FIG. 5A and FIG. 5B are close ups of the hose nozzle housing of the embodiment of FIG. 1. FIG. 5A showing the hose nozzle in the stowed state, in the nozzle housing; and FIG. 5B showing the nozzle housing moved so that the hose nozzle is in an exposed state, ready for use.

FIG. 5B shows the hose nozzle 120 in an exposed state, with the loop 160 of the nozzle housing 140 everted to expose the hose nozzle 120.

In an alternative embodiment, the nozzle housing (not illustrated) is sleeve-shaped, enclosing the hose nozzle like a sleeve. The nozzle housing has an opening to allow the hose nozzle to protrude beyond the nozzle housing to move to an exposed state. The sleeve with enclosed hose nozzle forms the handle portion. The sleeve is made of any suitable material. An example is neoprene, which is comfortable to hold. Its thermal insulation properties are a further advantage in the event that the sleeve were to become wet. Part of the sleeve may also bear corresponding parts of hook-and-loop fastener at opposing ends, allowing the handle portion to be worn as a cuff (e.g. around the wrist) rather than constrained to being hand-held. This is useful if carrying other items (e.g. sporting equipment) while walking an animal as it frees the hands.

The hose nozzle 120 shown in the figures is by way of example only. The hose nozzle 120 is any suitable nozzle attachment such as a nozzle for a standard garden hose. Ideally it is a slimline nozzle in form and made of lightweight material (e.g. aluminium, plastic), for comfort and portability. For example, the hose nozzle 120 of FIG. 1 is depicted as a trigger nozzle (with trigger 125 to assist in controlling the flow of water) but could be any nozzle—preferably, an adjustable nozzle or spray nozzle.

The hose nozzle 120 is connected to the hose portion 110 by any suitable hose coupler. The hose coupler 190a is shown in FIG. 1 as clamping both the nose nozzle 120 and the nozzle housing 140 to the hose portion 110.

At the far end of the hose portion 110 is a tap connector 130 for connecting the animal leash 100 to an available tap (see FIG. 1 and FIG. 3, the tap connector is not illustrated in FIG. 2A and FIG. 2B but would connect to the end of the hose portion 110 that extends out from the leash housing 22o). The tap connector 130 is any suitable hose connector such as a connector for a standard garden hose.

As with the hose nozzle, the tap connector 130 has its own moveable housing 150, allowing the tap connector 130 also to be moveable between an “exposed” stat and a “stowed” state. In the embodiment 200 of FIG. 2A, FIG. 2B and FIG. 3, the tap connector 130 may remain the same as in the embodiment 100 of FIG. 1, but the hose nozzle 120 forms part of a leash housing 220. The leash housing 220 houses the hose portion 110 when retracted and also functions as a handle for the animal leash 200. The leash housing 220 includes a retractor mechanism 260 (see FIG. 2A and FIG. 2B) that allows the hose portion 110 to be moved between an extended state and a retracted state. In both cases at least one end of the hose portion 110 is retained within the leash housing 220. In the extended state, the far end of the hose portion 110 extends out of the leash housing 220 for a length determined by the distance between animal being lead and the carer of the animal. This length can very to allow the distance between animal and carer to vary (up to a maximum length, as determined by the length of the hose portion 110). Alternatively, this distance can be fixed by the carer, by using the locking means 230 (See FIG. 2A, FIG. 2B and FIG. 3).

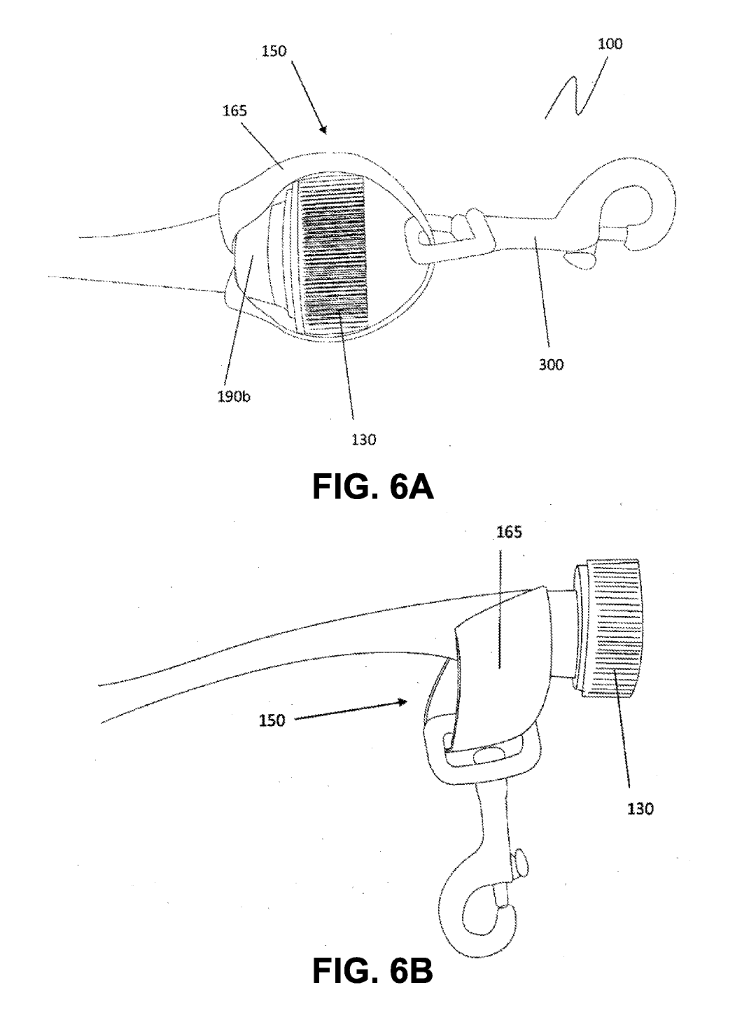

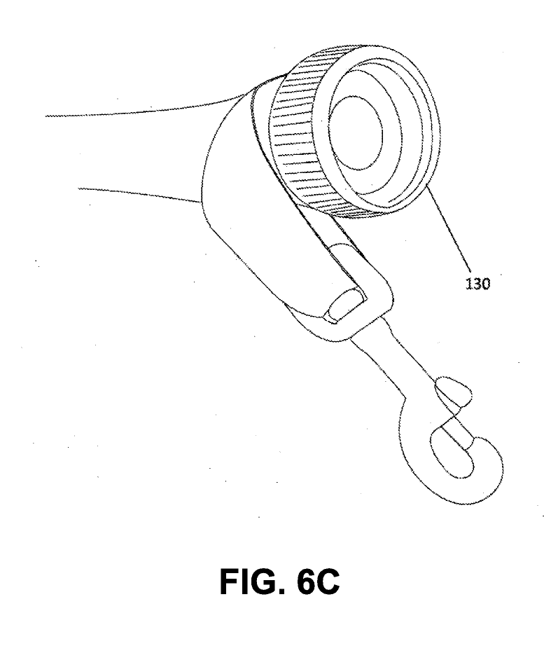

The connector housing 150 (FIG. 1, FIG. 3, FIG. 6A, FIG. 6B and FIG. 6C) is of similar construction to the nozzle housing 140. The connector housing 150 is shown in FIG. 1 as a length of nylon webbing, neoprene, elastic tubing or other suitable material attached at its far ends to the hose portion, to form a loop that can be positioned around the tap connector 130.

It will be appreciated that FIG. 6A to FIG. 6C disclose a close up of the tap connector and connector housing of the embodiment of FIG. 1. FIG. 6A shows a plan view of embodiment of FIG. 1 showing the tap connector in the stowed state, in the connector housing. FIG. 6B shows a plan view of the same embodiment as in FIG. 6A, showing the connector housing moved so that the tap connector is in an exposed state, ready for use—i.e. available for connection to a tap. FIG. 6C shows a perspective view of the tap connector of FIG. 6B, showing the inside of the tap connector.

A close up of the connector housing 150 of FIG. 1 is shown FIG. 6A to FIG. 6C. In its stowed state, the tap connector 130 sits within the loop 165 of the connector housing 150 (FIG. 6A). The tap connector 130 fits snugly within the loop 165, assisting to secure it within the connector housing 150. Thus the connector housing 150 can also serve as securing means to secure the tap connector 130 to the connector housing 150. Alternatively, the connector housing 150 can be a neoprene sleeve or other suitable housing to stow the tap connector 130 on the animal leash 100.

FIG. 6B shows the tap connector 130 in an exposed state, with the loop 165 of the connector housing 150 everted to expose the tap connector 130. FIG. 6C shows the exposed tap connector 130 from inside—the part that attaches to a tap can be seen.

As with the hose nozzle 120, the tap connector 130 is connected to the hose portion 110 by any suitable hose coupler 190 (depicted as 190b in FIG. 1 to differentiate it from the house coupler securing the hose nozzle 120 to the hose portion 110—in reality, 190a and 190b may be identical forms of hose connector). The hose coupler 190b is shown in FIG. 1 as clamping both the tap connector 130 and the connector housing 150 to the hose portion 110.

The animal leash 100 includes a clip 300 (e.g. see FIG. 6A to FIG. 6C) for clipping the animal leash 100 to an animal collar or harness. The clip 300 depicted is a standard leash clip but can be any suitable clip including a carabiner. The clip 300 is attached to the loop 165 of the connector housing 15o, and can be used to move the connector housing 150 to expose or stow the tap connector 130 within.

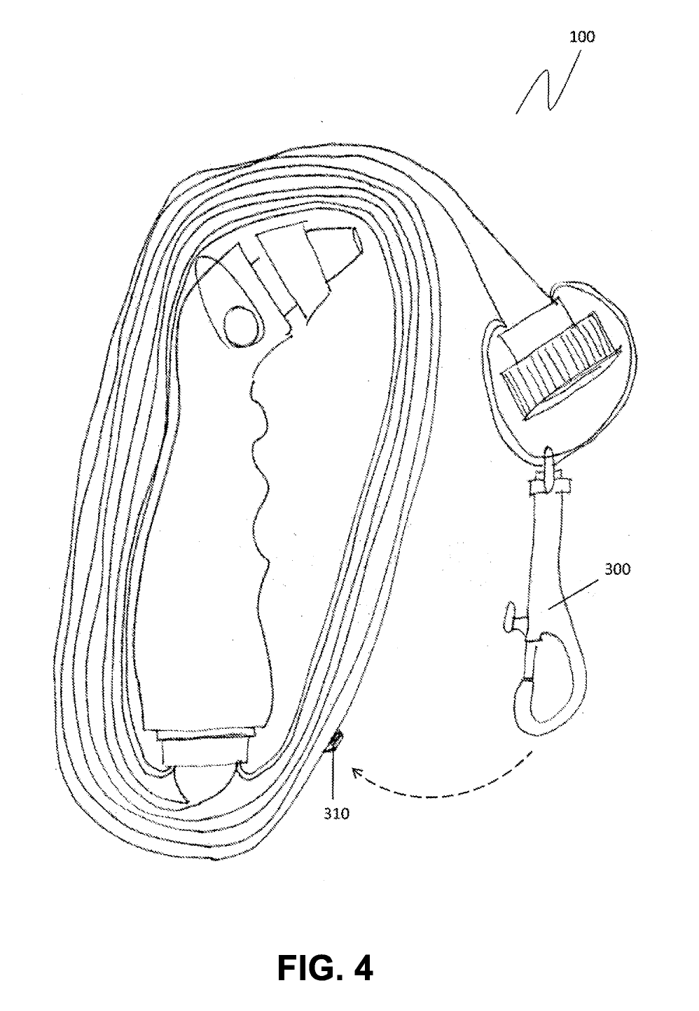

The animal leash 100 may be coiled for packing, transport and storage, as shown in FIG. 4. In an embodiment, the animal leash 100 includes a hook 310 (e.g. loop or connector made of textile or any other suitable material) positioned on the hose portion 110. Securing the clip 300 to the hook 310 (e.g. in the direction of the dashed arrow) assists to hold the clip 300 in place when the animal leash 100 is coiled for transport or storage.

The animal leash may be of a fixed length as shown in FIG. 1, or be an extendable and retractable animal leash as shown in FIG. 2A, FIG. 2B and FIG. 3. In the retractable embodiment 200 of FIG. 2A and FIG. 2B and FIG. 3, the animal leash further includes a leash housing 220 into which a length of hose portion 110 can be reversibly retracted and housed. The leash housing 220 of the retractable embodiment 200 can be any suitable shape (e.g. as shown in FIG. 2A, FIG. 2B and FIG. 3) and includes a retractor mechanism 26o, a locking means to lock/brake and unlock retraction of the hose portion 110 (e.g. lock button 230), a hose nozzle 120 (preferably adjustable, as in the embodiment 100). In embodiment 200, the leash housing 220 may include a trigger 125 to control the flow of water (e.g. as shown in FIG. 3).

The retractor mechanism 26o includes a central spigot 250 that can rotate in the direction shown by the double-headed arrows in FIG. 2A and FIG. 2B (namely, clockwise and counter-clockwise). In this arrangement, the end of the hose portion no that sits within the leash housing 220 is connected to the central spigot 250. A connection means 270 between the hose portion 110 and the central spigot 250 allows for water to flow in the direction of the central spigot 250 when the hose portion 110 is in an extended state (see FIG. 2A and FIG. 2B). The connection means 270 also allows for water flow from the central spigot 250 to the hose portion 110 when the hose portion 110 is in its extended state. Water flow from the central spigot 250 to the nozzle 120 is shown by the dashed lines marked with the letter Y in FIG. 2A and FIG. 2B.

The leash housing 220 includes a handle portion 175 for carrying the retractable animal leash 200. In FIG. 3, the handle portion 175 includes a 90° return, allowing for different hand positions when holding the leash housing 220. In the arrangement of FIG. 2A and FIG. 2B, the handle portion 175 is an ergonomic handle of any suitable shape.

Other features of the retractable embodiment 200 are the same as embodiment 100 of FIG. 1 (e.g. tap connector housing 150, the house coupler 190b).

An advantage of the animal leash 100, 200 is that it facilitates washing down of an animal anywhere there is a tap available, while also function as a simple and functional animal leash, making it portable and easy to carry with an animal at all times.

Although the invention has been described with reference to specific examples, it will be appreciated by those skilled in the art that the invention my be embodied in many different other forms.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

As used herein, unless otherwise specified the use of terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader, or with reference to the orientation of the structure during nominal use, as appropriate. Similarly, the terms “inwardly” and “outwardly” generally refer to the orientation of a surface relative to its axis of elongation, or axis of rotation, as appropriate.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. Functionality may be added or deleted from the schematic diagrams and operations may be interchanged among functional blocks. Steps may be added or deleted to methods described within the scope of the present invention.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein.

The claims defining the invention are as follows:

1. An animal leash apparatus comprising:
an elongate hose portion having opposing ends;
a hose nozzle at one end of the hose portion;
a tap connector at the other end of the hose portion; and
a clip at the same end of the hose portion as the tap connector, for enabling the animal leash to be coupled to an article worn by an animal.

2. The apparatus according to claim 1, wherein the hose nozzle is housed in a nozzle housing, which resides at one end of the hose portion.

3. The apparatus according to claim 2, wherein the nozzle housing is moveable to allow the hose nozzle to be moved between an exposed state for use and a stowed state when not in use.

4. The apparatus according to claim 3, wherein the tap connector is housed in a connector housing, which resides at a far end of the hose portion.

5. The apparatus according to claim 4, wherein the connector housing is moveable to allow the tap connector to be moved between an exposed state for use and a stowed state when not in use.

6. The apparatus according to claim 5, wherein the hose portion is a woven integral hose made of suitable textile which is coated or lined.

7. The apparatus according to claim 6, wherein the textile is selected from one or more of the set comprising: polyester, nylon filament;

8. The apparatus according to claim 6, wherein which the textile is coated or lined with elastomeric polyurethane.

9. The apparatus according to claim 1, wherein the tap connector is housed in a connector housing, which resides at a far end of the hose portion.

10. The apparatus according to claim 9, wherein the connector housing is moveable to allow the tap connector to be moved between an exposed state for use and a stowed state when not in use.

11. The apparatus according to claim 1, wherein the hose portion is a woven integral hose made of suitable textile which is coated or lined.

12. The apparatus according to claim 11, wherein which the textile is coated or lined with elastomeric polyurethane.

13. The apparatus according to claim 11, wherein the textile is selected from one or more of the set comprising: polyester and nylon filament.

14. The apparatus according to claim 13, wherein which the textile is coated or lined with elastomeric polyurethane.

15. The apparatus according to claim 1 wherein the article worn by an animal is an animal collar.

16. The apparatus according to claim 1 wherein the article worn by an animal is an animal harness.
